(19) United States
(12) Patent Application Publication
(10) Pub. No.: US 2019/0263410 A1
(43) Pub. Date: Aug. 29, 2019

(54) DRIVER SUPPORT METHOD FOR A VEHICLE

(71) Applicant: VALEO Schalter und Sensoren GmbH, Bietigheim-Bissingen (DE)

(72) Inventors: Xavier Groult, Bobigny (FR); Alexandre Garnault, Bobigny (FR)

(73) Assignee: VALEO Schalter und Sensoren GmbH, Bietigheim-Bissingen (DE)

(21) Appl. No.: 16/277,290

(22) Filed: Feb. 15, 2019

(30) Foreign Application Priority Data
Feb. 23, 2018 (DE) 10 2018 104 104.7

(51) Int. Cl. B60W 30/18; B60W 30/095; G05D 1/02; B60W 40/04; G08G 1/16

(52) U.S. Cl. CPC B60W 30/18163; B60W 30/0956; G05D 2201/0213; B60W 40/04; G08G 1/167; G05D 1/0223

(57) ABSTRACT

The present invention refers to a driver support method for an ego vehicle (10), wherein the ego vehicle (10) travels on an ego lane (14) and wherein next to the ego lane (14), an emergency lane (18) is provided, the method comprising the steps of:
a) Monitoring the emergency lane (18);
b) Determining, if a vehicle (20) is present on the emergency lane (18) in front of the ego vehicle (10); and
c) before the ego vehicle (10) passes the vehicle (20) located on the emergency lane (18), performing at least one of
c1) changing the lateral position of the ego vehicle (10) in order to increase the lateral distance to the emergency lane (18); and
c2) decreasing the speed of the ego vehicle (10).

The present invention refers to a driver support method for a vehicle. The present invention particularly refers to a driver support method which improves security in case of an emergency which happened in front of a vehicle. The present invention further relates to a driver support system which is adapted for performing such a method.

Different methods are known for sensing roads vehicles are travelling on and for handling the information reached therewith. With regard to assisted driving or even fully autonomous driving it is known that the road is sensed for detecting further vehicles which are provided on the ego lane.

U.S. Pat. No. 9,092,977 B1 describes a controlled vehicle that detects the presence of an emergency vehicle by monitoring the trajectories of vehicles that are sharing the road with the controlled vehicle. The controlled vehicle may determine that the trajectory of each of the monitored vehicles follows the same predetermined pattern. Based on detecting the predetermined pattern in the behaviour of the monitored vehicles, the controlled vehicle may deduce that an emergency vehicle is present in the vicinity of the monitored vehicles and/or the controlled vehicle. In response, a state of the vehicle is changed, such as stopping, accelerating, decelerating, changing lanes and activating a blinker. However, this document particularly refers to emergency vehicles of oncoming traffic or emergency vehicles which are located behind the ego vehicle.

U.S. Pat. No. 8,842,021 B2 describes a system and a method for warning of emergency vehicles including a computing device that receives location data from a transmitter associated with a first vehicle based on a warning system of the first vehicle being activated. The computing device transmits vehicle notification data to a second vehicle based on the location data.

US 2016/252905 A1 describes a system and a method for detecting and responding to emergency vehicles. In one aspect, one or more computing devices may identify a set of light sources from an image based at least in part on one or more templates, and may filter the set of light sources in order to identify one or more light sources corresponding to a potential emergency vehicle. Moreover, the one or more computing devices may determine whether any of the one or more light sources is flashing and whether any of the one or more light sources is associated with a particular type of the potential emergency vehicle. Further, the one or more computing devices may maneuver a vehicle based on the determination to yield in response to at least one of the one or more flashing light sources and the particular type of the emergency vehicle

Such methods, however, still give room for improvements especially with regard to passing a vehicle which is located in front of the ego vehicle.

It is thus an object of the present invention to overcome at least one disadvantage of the prior art. It is particularly an object of the present invention to provide a measure which reduces the danger occurring when an ego vehicle passes a further vehicle, such as an emergency vehicle.

These objects are solved at least in part by a method having the features of independent claim 1. These objects are further at least in part solved by a driver support system having the features of independent claim 14. These objects are further at least in part solved by a vehicle having the features of independent claim 15. Advantageous embodiments are given in the dependent claims, in the further description as well as in the figures, wherein the described embodiments can, alone or in any combination of the respective embodiments, provide a feature of the present invention unless not clearly excluded.

In particular, the present invention provides a driver support method for an ego vehicle, wherein the ego vehicle travels on an ego lane and wherein next to the ego lane, an emergency lane is provided, the method comprising the steps of:

a) Monitoring the emergency lane;
b) Determining, if a vehicle is present on the emergency lane in front of the ego vehicle; and
c) before the ego vehicle passes the vehicle on the emergency lane, performing at least one of
c1) changing the lateral position of the ego vehicle in order to increase the lateral distance to the emergency lane; and
c2) decreasing the speed of the ego vehicle.

This method may provide an advantageous measure for passing a vehicle on the emergency lane. For example, this method may provide an advantageous solution for passing an emergency vehicle which is located on an emergency lane in front of the ego vehicle and which is thus located in front of the ego vehicle regarding the driving direction of the ego vehicle.

The present invention thus provides a method of supporting a driver of an ego vehicle, wherein the ego vehicle travels on an ego lane of a road and wherein next to the ego lane, an emergency lane is provided. With this regard and according to the present invention, an ego vehicle should be the vehicle which performs the method like described. Further, according to the present invention, the ego lane is particularly that lane the ego vehicle is initially positioned on. Preferably, the ego vehicle is moving on the ego lane, or travelling on the ego lane, respectively. Apart from that, an emergency lane is particularly a lane which should not be used for intentional travelling but should be used in case of an emergency, such as a vehicle breakdown or an accident. As known per se, the emergency lane conventionally is positioned at the most outer right part of the road.

Especially, the method shall provide information about vehicles being positioned on the emergency lane in order to take measures when passing such a vehicle. This allows giving driving information to a driver, to give a warning to a driver, to give further driving support or even to allow fully automated driving or fully autonomous driving, respectively.

Further, the method may particularly be performed by means of a driver support system which is part of the ego vehicle. The driver support system may comprise one or a plurality of environmental sensors, and further a control unit. The control unit is configured for performing the method as described like will be disclosed in more detail down below.

The present driver support method comprises the following steps.

According to step a) the present method comprises the step of monitoring the emergency lane. According to this step, a monitoring step is performed on the emergency lane in order to allow method step b) according to which it is determined, if a vehicle is present on the emergency lane in front of the ego vehicle, which particularly means in front of the ego vehicle in a driving direction of the ego vehicle.

Therefore, this step is performed in order to detect a situation in which the ego vehicle travels on the ego lane, wherein next to the ego lane an emergency lane is provided. This situation often appears for example on motorways or comparable roads. Sensing the emergency lane may be performed by sensors of a driver support system as it is generally known per se. For example, the sensor may be selected from the group consisting of ultrasonic sensors, cameras, LIDAR-based sensors, such as laserscanners, radar sensors.

As the provision of an emergency lane next to the ego lane and preferably adjacent to the ego lane is an important factor, it is preferably provided that the method comprises the further step:

d) Detecting, if the ego lane is positioned next to an emergency lane, for example if the ego lane is positioned adjacent to an emergency lane. This step may preferably ensure that the present method allows the advantages as described in a very efficient manner and may really reflect the prerequisites as described.

With this regard, it may be advantageous that step d) and thus detecting, if the ego lane is positioned next to an emergency lane, comprises detecting the speed of the vehicle being positioned on the emergency lane. With this regard, it is mostly provided that in case a vehicle is positioned on an emergency lane, the latter stands still or moves with a limited speed, only. Therefore, determining the speed of the vehicle being located on the emergency lane may give a hint with regard to the present situation, i.e. if the ego vehicle travels on a road having an emergency lane and in more detail if the ego vehicle travels on an ego lane which is situated next to such as adjacent to an emergency lane. Thus, a speed limit which indicates a vehicle being present on an emergency lane may be stored in the control unit of the driver support system.

The speed of the vehicle being present on the emergency lane may be detected for example by detecting the relative longitudinal speed of the vehicle being present on the emergency lane with regard to the ego vehicle. Further, by taking into consideration the speed of the ego vehicle the absolute speed of the vehicle being present on the emergency lane may be calculated.

Additionally or alternatively, the speed of the ego vehicle as such may be taken into consideration when performing step d). This step may allow evaluating if the ego vehicle is traveling on a motorway and may thus give an estimation if an emergency lane is present. This is mostly possible as motorways mostly comprise emergency lanes and thus detecting a speed which generally may be reached only on motorways is a strong hint for the presence of an emergency lane.

Further with regard to step d) and thus with regard to detecting, if the ego lane is positioned next to such as adjacent to an emergency lane, this step may comprise sensing at least one of road markings and traffic signs. With this regard, it is mostly provided that in case an emergency lane is present, such an emergency lane is separated by the lanes which are intended for conventional travelling by distinct road markings or that special traffic signs are provided. These road markings may be different from road markings separating conventional lanes which are intended for conventional driving for example in that the respective road markings comprise a special length, pattern and/or color. Therefore, sensing the road markings or traffic signs may give a hint with regard to the present situation, i.e. if the ego vehicle travels on a road having an emergency lane and in more detail if the ego vehicle travels on an ego lane which is situated next to such as adjacent to an emergency lane and for example on the most right lane. Again, sensing the road markings or traffic signs may generally be performed by conventional sensors such as ultrasonic sensors, cameras, LIDAR-based sensors, such as laserscanners, radar sensors.

It may further be provided that different and specific arrangements of road markings may be stored in a driver support system such as in its control unit which performs the method as described, wherein the driver support system may define whether an emergency lane is present and if the emergency lane is located directly adjacent to the ego lane or if further lanes are provided there between by detecting the position of respective lane markings and traffic signs.

Additionally or alternatively with regard to step d) and thus to detecting, if the ego lane is positioned next to an emergency lane such as adjacent to an emergency lane, this step may comprise using data of a navigation system, especially in combination with using position data, such as GPS data of the ego vehicle. With this regard, it is mostly provided that navigation systems do comprise information not only of the road and its course but also about the lanes which are present on that road at a special location. Therefore, using information of a navigation system may give effective and reliable information with regard to the present situation, i.e. if the ego vehicle travels on a road having an emergency lane and in more detail if the ego vehicle travels on an ego lane which is situated next to such as adjacent to an emergency lane.

Additionally or alternatively with regard to step d) and thus to detecting, if the ego lane is positioned next to an emergency lane such as adjacent to an emergency lane, this step may comprise counting the number of lane changes after entering the road the ego lane is positioned on. This embodiment may be called lane number identification, or lane counting, respectively. With this regard, it may be provided that a counter is set to 0 when the ego vehicle enters the road, such as a highway, and increments when vehicle changes lane on the left, and decrements when changes lane on the right. Therefore, if the current value is 0, the ego vehicle may determine that it is on the most right lane, and when the value equals the maximum number of lanes on the current highway section, the vehicle knows it is on the most left lane. Being on the most right lane may give a hint that the ego lane is adjacent to an emergency lane.

It may be provided that single or a defined number or all of the before named parameters may be used for performing step d). With this regard, as some parameters may give an estimation if an emergency lane is present but some of them cannot give an unequivocal definition, especially using a plurality or all of the parameters as described may give an especially reliable estimation regarding the existence of an emergency lane which is located adjacent to the ego lane.

Thus, especially in case it was determined if an emergency lane is provided next to the ego lane such as adjacent to the ego lane, and thus particularly after step d), the emergency lane may be monitored and it should thereby be detected, if a vehicle is present on the emergency lane in front of the ego vehicle. This may be performed by means of one or more sensors like described before and by using a respective algorithm as it is generally known in the art.

The provision of a vehicle on the emergency lane may indicate a potentially dangerous situation as often a vehicle on the emergency lane indicates the provision of an emergency or a vehicle breakdown. With this regard, it may be the case that objects may be positioned such, that they are located at least partly in the lane being adjacent to the emergency lane and thus e.g. in the ego lane. Apart from that, the provision of an emergency or a vehicle breakdown may indicate that persons are located on the emergency lane which as well may provide a dangerous situation.

The present method particularly deals with acting against such dangerous situations.

In order to prevent such a dangerous situation, the present method comprises, especially in case the provision of a vehicle on the emergency lane was detected, the further method step c) according to which, before the ego vehicle passes the vehicle on the emergency lane, performing at least one of

c1) changing the lateral position of the ego vehicle in order to increase the lateral distance to the emergency lane; and
c2) decreasing the speed of the ego vehicle.

Thus, it may be provided that only step c1) or only step c2) or both of steps c1) and c2) are performed. This step c) allows significantly improving the situation of passing a vehicle on the emergency lane.

Due to step c1) according to which before the ego vehicle passes the vehicle on the emergency lane, the lateral position of the ego vehicle is changed in order to increase the lateral distance to the emergency lane, it may be avoided that the ego vehicle passes the vehicle on the ego lane in a lateral distance which is too small. In contrast thereto, as the lateral distance of the ego vehicle to the emergency lane and thus to the vehicle being located thereon is increased, the danger of coming in conflict with the vehicle, objects occurring with this regard, or with persons accompanying the vehicle is significantly reduced.

Thus, passing the vehicle on the emergency lane is significantly improved with regard to safety issues as a safe distance to the emergency lane is kept. Especially dangerous situations occurring with this regard may thus be avoided.

With regard to detecting when the ego vehicle passes the vehicle on the ego lane, this may be calculated in an easy manner by calculating the distance of the ego vehicle to the vehicle on the emergency lane and further by taking into consideration the speed of the ego vehicle.

Further and with regard to the lateral shift of the ego vehicle according to step c), the latter may be performed by assisting the driver by giving information, by performing a steering or breaking intervention or by providing fully automated driving.

It may be preferred that step c1) comprises performing a lane change of the ego vehicle to a lane being more remote to the emergency lane than the ego lane. In other words, step c) and thus changing the lateral position of the ego vehicle before the ego vehicle passes the vehicle on the emergency lane in order to increase the lateral distance to the emergency lane, is performed by not making a lateral shift, or change of the lateral position, respectively, within the ego lane, only, but a lane change is performed. Therefore, the ego vehicle continues its travel on a lane which is more remote from the emergency lane allowing at least one lane being present between the ego vehicle and the emergency lane when the ego vehicle passes the ego lane.

The method according to this embodiment acts against conventional driver support systems as these systems according to the prior at mostly act using a lane centering feature which additionally gives the instruction that the ego vehicle travels on the most right lane except for an overtaking action. However, according to this embodiment, a very effective improvement with regard to safety may be reached by changing the lane which is used.

It may especially be provided that a lane being adjacent to the ego lane in an opposite direction compared to the emergency lane may be used as target lane.

With regard to a lane change which may be performed, it may be especially preferred that before step c) is performed and thus potentially a lane change is affected, the method comprises the further step:

e) Sensing at least a lane being adjacent to the ego lane in an opposite direction regarding the emergency lane and determine, if a lane change to that lane is critical.

Given the above, it may especially be provided that a lane change to that lane is not critical, if no vehicle approaches the ego vehicle from behind and/or is present in a longitudinal distance to the ego vehicle which is larger compared to a predetermined value or has a speed being smaller than a predetermined value. In this case, a lane change may be performed without being critical. In contrast to this, in case a vehicle is present at that target lane in a distance to the ego vehicle being smaller than a predetermined distance or even if the vehicle on that target lane approaches the ego vehicle and has a speed being larger than a predetermined value, a lane change may be critical and may thus be avoided. According to this, a critical situation may be avoided and thus the improvement with regard to security is especially effective.

It may further be provided that step c1) comprises performing a lateral shift within the ego lane without performing a lane change. Again, the method according to this embodiment acts against conventional driver support systems as these systems mostly act for the ego vehicle to drive on the lateral central position on the ego lane and thus with a lane centering feature.

This feature allows improving the security behaviour when passing a vehicle being positioned on an emergency lane independently if a lane change is possible or not and thus even in case a lane change should be avoided. Therefore, computing power may be saved and additionally this step may be performed in any situation so that according to this embodiment, the whole method according to the invention may be performed in any case. Further, in case step e) gives the outcome that a lane change is critical, the lateral distance to the emergency lane can anyhow be enlarged. As an example, a typical lateral shift within, the ego lane may lie in the range of 50 cm, for example. This should not make a significant decrease in safety regarding the side opposite direction of the emergency lane but may on the other hand effectively increase safety when passing the vehicle on the emergency lane.

It should further be noted that with regard to the lateral shift of the ego vehicle within the ego lane, it may be provided that this shift is performed only until the ego vehicle reaches a lateral end of the respective lane. With this regard, it may be preferred that a defined security range is taken into consideration so that at least a defined space between the lane boundary and the ego vehicle is provided. This embodiment may be realized, for example, by detecting road markings or further lane boundaries, which may easily be performed by sensors known in the art, such as cameras, for example.

Summarizing the above, it may be provided that in order to keep a safe distance to the emergency lane and the vehicle located thereon, it is detected, if a lane change is possible. In case a lane change is possible, this is performed by means of step c1). In case a lane change would not be safe, for example in case a conflict with a vehicle which travels on a neighbor lane behind or next to the ego vehicle may occur, the lateral movement is performed only within the ego lane, but no lane change is performed. Given this, it becomes clear that the lateral movement according to step c) is performed always with the greatest possible safety and thus in turn the vehicle on the emergency lane is passed always with the largest possible safety.

It may further be preferred that the method comprises the further step:
g) changing the lateral position of the ego vehicle back to the initial lateral position, and thus to the position before step c1) was performed, after passing the vehicle on the emergency lane.

According to this embodiment, the safety may be increased after having passed the vehicle on the emergency lane as for example the lateral central position on the ego lane may be reached again or the most usable right lane may be used again. Therefore, after having passed the vehicle being present on the emergency lane, travelling is not affected anymore.

In order to further improve safety when passing the vehicle being present on the emergency lane, it may additionally or alternatively to step c1) be preferred that the method comprises the further step:

c2) decreasing the speed of the ego vehicle.

This step may further reduce the danger of a critical situation when passing the vehicle in the emergency lane as this embodiment allows passing the vehicle being present on the emergency lane with a lower speed compared to the initial speed. Thus, for example, persons being present on the emergency lane are able in a more reliable manner to take notice of the approaching ego vehicle.

However, according to the present invention, a lane change or a lateral movement of the ego vehicle within the ego lane may be preferred. Therefore, it might be preferred that it is firstly evaluated if step c1) may be performed safely and step c2) is performed, in case step c1) is not possible. It may however be additionally possible that both steps c1) and c2) are performed. With regard to step c1), a lane change may be preferred with regard to a lateral movement within the ego lane.

It may further be preferred that the method comprises the further step:

h) Increasing the speed of the ego vehicle after passing the vehicle on the emergency lane back to the initial speed.

Again, this embodiment may allow affecting the conditions of travelling after having passed the vehicle on the emergency lane not more than strictly required so that traveling as a whole may again be performed according to the parameters before passing the vehicle being present on the emergency lane. With regard to the initial speed, this may particularly be that speed which was used before step c2).

With regard to increasing or decreasing the speed of the ego vehicle, it may be provided that this action is performed only in case it is safe and thus not critical. For example, increasing the speed may not be performed in case the distance to a vehicle before the ego vehicle will become too less and would thus lie beneath a predetermined value or if a speed limit would be exceeded. Further, decreasing the speed may not be performed in case the distance to a vehicle behind the ego vehicle will become too less and would thus lie beneath a predetermined value. Thus, in case decreasing or increasing the speed as such would lead to a critical situation, these steps may be omitted.

It may further be provided that step b) comprises detecting, if the vehicle being located on the emergency lane is an emergency vehicle. This step may allow even more effectively to evaluate if the situation the ego vehicle is approaching is an emergency and thus if passing this emergency vehicle is critical. Therefore, the steps to take may further be adjusted. For example, it might be provided that in case a vehicle not being an emergency vehicle is present on the emergency lane, a lateral movement may be provided within the ego lane independently, if a lane change would generally be possible. Alternatively or additionally, it might be defined that the speed of the ego vehicle is kept constant. On the other hand, in case an emergency vehicle is detected, a lane change and reducing the speed of the ego vehicle may be preferred.

The detection of an emergency vehicle may for example be reached by sensing the color of the vehicle on the emergency lane. Further, this step may be reached by detecting, if an emergency light, or gyrophare, respectively is present and potentially if an emergency light is turned on. Therefore, this step may be performed by sensing the environment for example with a camera and by performing respective image processing like it can be generally performed without problems by the person skilled in the art.

With regard to further advantages and technical features of the method, it is referred to the driver support system, the vehicle, the figures and the further description.

The present invention further relates to a driver support system for a vehicle, comprising at least one environmental sensor which is adapted for sensing the environment of the vehicle, further comprising a control unit for processing the data provided by the at least one environmental sensor, wherein the control unit is configured for performing a method like it is described in detail above.

Therefore, the driver support system may be part of the ego vehicle as it is generally known in the art. It comprises one or a plurality of environmental sensors which are adapted for sensing the environment. For example, one or more cameras may be provided for sensing the environment and especially for detecting lane markers. Further, sensors which may be comprised by the driver support system may inter alia comprise ultrasonic sensors, cameras, LIDAR-based sensors, such as laserscanners, radar sensors.

Apart from that, a control unit is provided. This control unit is fed with the information provided by the one or more environmental sensors and is adapted for performing the method as described. Having performed steps a) and b), the outcome may be used for performing a lateral shift according to step c1) or a decrease in speed according to step c2) e.g. by a system which is suited for performing autonomous driving or it may simply give information to a driver or may further support the driver of a vehicle.

Such a driver support system may particularly provide improved safety behavior for different driving sequences especially by enlarging the safety distance between the ego vehicle and the emergency lane and thus between the ego vehicle and a vehicle being positioned on the emergency lane and/or by reducing the speed of the ego vehicle.

With regard to the driver support system, it might be provided that a level 2 system is provided at minimum and thus a system which is active in longitudinal control and lateral control. Therefore such systems may control lane centering and automated lane change. Especially such driver support systems may be especially preferred for performing the present method as described.

With regard to further advantages and technical features of the driver support system, it is referred to the method, the vehicle, the figures and the further description.

The present invention further relates to a vehicle comprising a driver support system wherein the driver support system is configured as described above.

Like stated above in more detail, such a vehicle allows improved safety behavior for different driving sequences especially by enlarging the safety distance between the ego vehicle and the emergency lane and thus between the ego vehicle and a vehicle being positioned on the emergency lane.

With regard to further advantages and technical features of the vehicle, it is referred to the method, the driver support system, the figures and the further description.

These and other aspects of the invention will be apparent from and elucidated with reference to the embodiments described hereinafter. Individual features disclosed in the embodiments con constitute alone or in combination an aspect of the present invention. Features of the different embodiments can be carried over from one embodiment to another embodiment.

In the drawings:

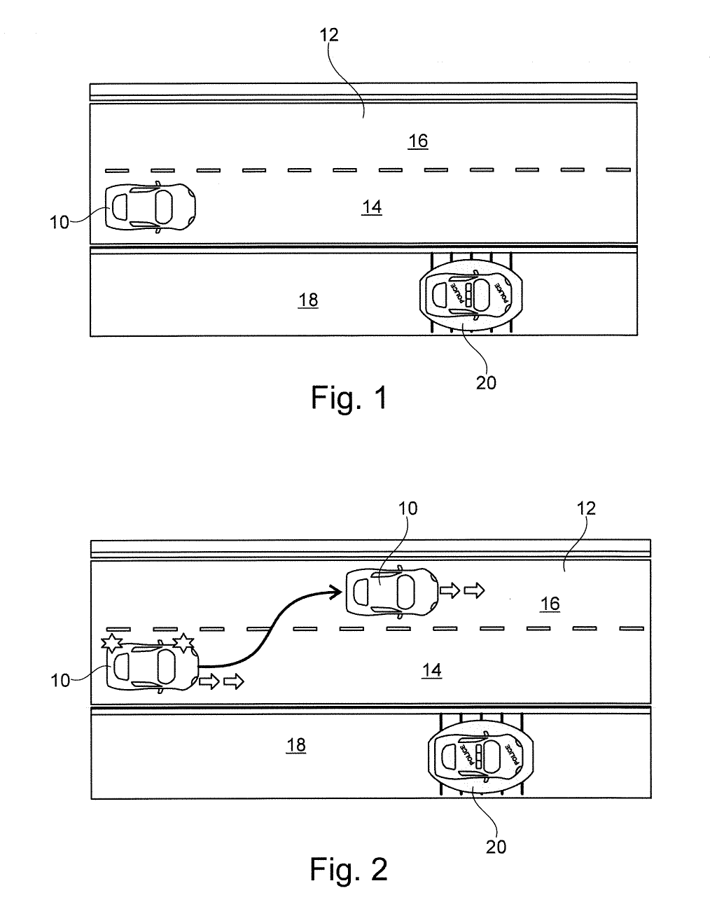

FIG. 1 shows a schematic view of an ego vehicle driving on an ego lane in a first situation, wherein the ego lane is positioned adjacent to an emergency lane;

FIG. 2 shows a schematic view of the ego vehicle driving in the situation of FIG. 1 after a lane change;

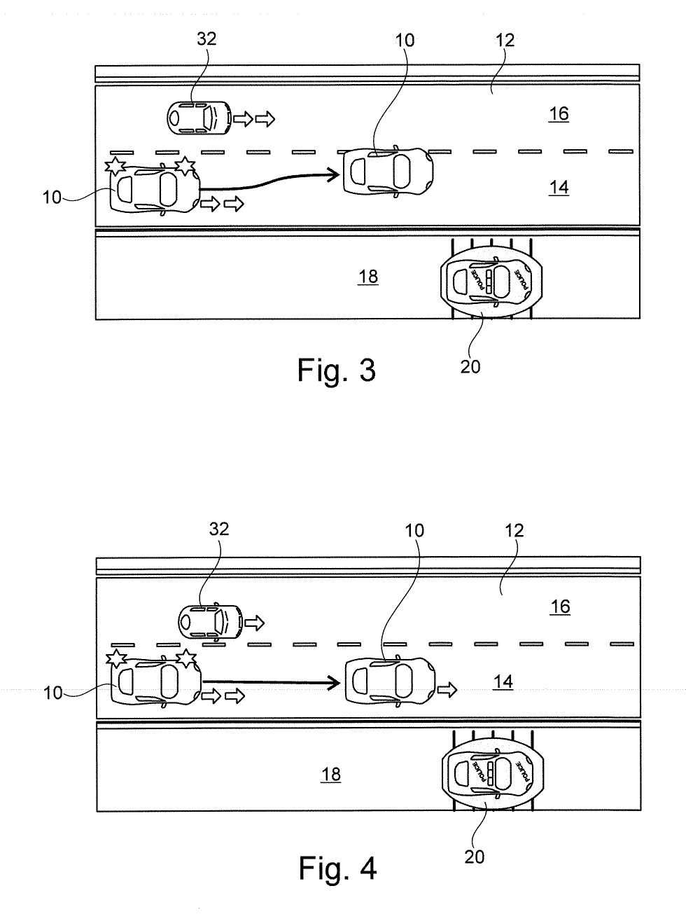

FIG. 3 shows a schematic view of an ego vehicle driving on an ego lane in a second situation, wherein the ego lane is positioned adjacent to an emergency lane;

FIG. 4 shows a schematic view of an ego vehicle driving on an ego lane in a third situation, wherein the ego lane is positioned adjacent to an emergency lane; and

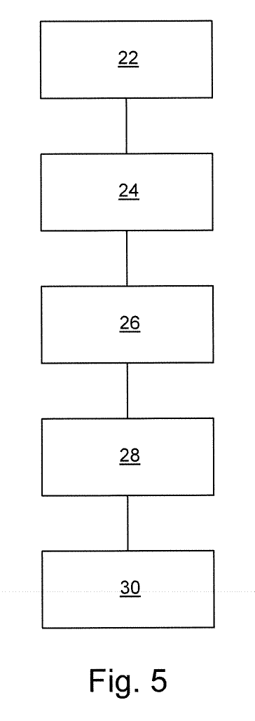

FIG. 5 showing a block diagram indicating the method according to the invention.

FIG. 1 shows a schematic view of an ego vehicle 10 driving on a road 12. In detail, the ego vehicle 10 travels on an ego lane 14 of the road wherein, adjacent to the ego lane 14 the road comprises a second lane 16, wherein the second lane 16 is well is provided for conventional driving and is located adjacent to the ego lane 14 and opposite to an emergency lane 18, which as well is located adjacent to the ego lane 14. It can further be seen that on the emergency lane 18 in in the driving direction of the ego vehicle 10 in front of the ego vehicle, a vehicle 20 is provided. In more detail, the vehicle 20 is an emergency vehicle.

With regard to the ego vehicle 10, the latter may comprise a driver support system which comprises at least one environmental sensor, such as a plurality of environmental sensors. The at least one environmental sensor may be selected from the group consisting of ultrasonic sensors, cameras, LIDAR-based sensors, such as laserscanners, radar sensors, wherein one or a plurality of the same or different sensors may be provided. Further, the driver support system comprises a control unit for processing the data provided by the at least one environmental sensor and may take an action based on that outcome or based on data calculated from that outcome. Thus, the ego vehicle 10 may be a fully autonomous driving vehicle or it may support the driver by performing driving actions or by giving information.

As the ego vehicle 10 will pass the emergency vehicle 20 on the emergency lane 18, a potentially hazardous situation may occur especially in case the lateral distance between the ego vehicle 10 and the vehicle 20 is comparably small. In order to increase this situation and to reduce the danger of passing the vehicle 20, such as the emergency vehicle, the ego vehicle 10 or its driver support system, respectively, may perform a method as it is described in FIG. 5.

In detail, FIG. 5 shows a block diagram indicating an embodiment of the method according to the invention.

The method comprises in an embodiment of the invention the following steps.

Like described above, the method may start in a situation in which the ego vehicle 10 is positioned on an ego lane 14 of the road 12, the method, however, not strictly being limited to this lateral position of the ego vehicle 10. This situation may be indicated by block 22.

Potentially, it may be provided that like indicated by block 24 the method may comprise the step of detecting, if the ego lane 14 is positioned next to an emergency lane 18, for example if the ego lane 14 is positioned adjacent to an emergency lane 18. This step may preferably ensure that the present method allows the advantages as described in a very efficient manner and may really reflect the prerequisites as described.

With this regard, it may be advantageous that this step according to block 24 may be performed by or may comprise sensing the speed of the vehicle 20 being positioned on the emergency lane 18. In case it is determined that the vehicle 20 stands still or moves with a limited speed, only, this may be strong hint that the vehicle 20 is positioned on an emergency lane 18.

Additionally or alternatively, the method step according to block 24 and thus the step of detecting, if the ego lane 14 is positioned next to an emergency lane 18, may take into consideration the speed of the ego vehicle 14. These steps may allow evaluating if the ego vehicle 14 is traveling on a motorway and may thus give an estimation if an emergency lane 18 is present and if the ego lane 18 is positioned adjacent to the emergency lane 18.

Further, for example in the embodiment as described before but not limited thereto, it may be provided that this step may comprise counting the number of lane changes after entering the road the ego lane is positioned on. This embodiment may be called lane number identification. With this regard, it may be provided that a counter is set to 0 when the ego vehicle enters the road, such as a highway, and increments when vehicle changes lane on the left, and decrements when changes lane on the right. This may allow evaluating in a very safe manner if the ego vehicle 10 is positioned on the most right lane and is thus positioned adjacent to the emergency lane 18.

Additionally or alternatively with regard to the step as indicated by block 24 may further comprise sensing road markings or traffic signs. With this regard, it is mostly provided that in case an emergency lane 18 is present, such an emergency lane 18 is separated by the lanes which are intended for conventional travelling, such as by the ego lane 14, by distinct road markings or that special traffic signs are provided. Therefore, again, strong hint to the provision of an emergency lane 18 and the relative position thereof with regard to the ego lane 14 may be given.

Additionally or alternatively with regard to the step as indicated by block 24 may further comprise using data of a navigation system, especially in combination with using position data, such as GPS data of the ego vehicle 10. With this regard, it is mostly provided that navigation systems do comprise information not only of the road 12 and its course but also about the lanes which are present on that road 12 at a special location. Therefore, using information of a navigation system may give effective and reliable information with regard to the present situation, i.e. if the ego vehicle 10 travels on a road having an emergency lane 18 and in more detail if the ego vehicle 10 travels on an ego lane 14 which is situated next to such as adjacent to an emergency lane 18.

Given this situation as described before and thus in case it is determined that the ego lane 14 is located adjacent to the emergency lane 18, block 26 indicates the step of monitoring the emergency lane 18. According to this step, thus, a monitoring step is performed with regard to the emergency lane 18 in order to allow determining, if a vehicle 20 is present on the emergency lane 18 in front of the ego vehicle 10.

After that method step and like indicated with regard to block 30, the method comprises the step of, before the ego vehicle 10 passes the vehicle 20 on the emergency lane 18, changing the lateral position of the ego vehicle 10 in order to increase the lateral distance to the emergency lane 18. This step allows significantly improving the safety behaviour and avoid-ing hazardous situations.

For example and with regard to the step of performing a lateral movement of the ego vehicle 10 it may be provided that this step comprises performing a lane change to a lane which is more remote to the emergency lane 18 than the ego lane 14 and thus, according to FIG. 2, to the second lane 16.

The method according to this embodiment acts against conventional driver support systems as these systems according to the prior at mostly act using a lane centering feature which additionally gives the instruction that the ego vehicle 10 travels on the most right lane except for an overtaking action. However, according to this embodiment, a very effective improvement with regard to safety may be reached by changing the lane which is used.

With regard to a lane change which may be performed, it may be especially preferred that before step d) is performed and thus before a lane change is affected, the method comprises the further step of sensing at least a lane being adjacent to the ego lane 14 in an opposite direction compared to the emergency lane 18, such as the second lane 16, and determine, if a lane change to e.g. second lane 16 is critical. This step is indicated by block 28.

With this regard, it may especially be provided that a lane being adjacent to the ego lane 14 in an opposite direction compared to the emergency lane 18, such as the second lane 16, is monitored in order to determine, if a lane change to that lane is critical. A lane change may in particular be safe if no vehicle 32 approaches the ego vehicle 10 from behind or is present in a longitudinal distance to the ego vehicle 10 which is larger compared to a predetermined value. In contrast, in case a vehicle 32 is present at that target lane in a distance to the ego vehicle 10 being smaller than a predetermined distance or even if the vehicle 32 on that target lane approaches the ego vehicle 10, a lane change may be critical and may thus be avoided.

Performing a lane change is shown in FIG. 2. Here, it is shown that the ego vehicle 10 leaves the ego lane 14 and changes to the second lane 16 in order to increase the distance to the vehicle 20.

A further embodiment of the method as described is shown in FIG. 3. According to FIG. 3, it can be seen that a lane change is not possible as a further vehicle 32 approaches on the second lane 20. Therefore, performing a lane change onto the second lane 16 as target lane would provide a critical situation.

Therefore, it is provided that the step of laterally moving the ego vehicle 10 comprises the step of performing a lateral shift within the ego lane 14 without performing a lane change.

However, the embodiment as described before may be especially preferred in case the further vehicle 32 has a lateral distance to the ego lane 14 lying above a defined bordervalue. Therefore, after having performed a lateral shift within the ego lane 18, there is still a lateral distance between the ego vehicle 10 and the further vehicle 32 which avoids a critical situation.

In case the further vehicle 32 has a lateral distance to the ego lane 14 lying beneath a defined value, like shown in FIG. 4, after having performed a lateral shift within the ego lane 14, the lateral distance between the ego vehicle 10 and the further vehicle 32 would be too small to avoid a critical situation. Therefore, according to this embodiment, a lateral shift of the ego vehicle 10 may be omitted. However, in order to improve the security behaviour, the method performs the step of decreasing the speed of the ego vehicle 10.

### REFERENCE SIGNS LIST

10 ego vehicle
12 road
14 ego lane
16 lane
18 emergency lane
20 vehicle
22 block
24 block
26 block
28 block
30 block
32 vehicle

1. A driver support method for an ego vehicle, wherein the ego vehicle travels on an ego lane and wherein next to the ego lane, an emergency lane is provided, the method comprising:
a) monitoring the emergency lane;
b) if determining when a vehicle is present on the emergency lane in front of the ego vehicle; and
c) before the ego vehicle passes the vehicle located on the emergency lane, performing at least one of:
c1) changing the lateral position of the ego vehicle to increase the lateral distance to the emergency lane; and
c2) decreasing the speed of the ego vehicle.

2. The method according to claim 1, wherein the method further comprises:
d) if detecting whether the ego lane is positioned next to an emergency lane.

3. The method according to claim 2, wherein step d) comprises sensing the speed of the ego vehicle.

4. The method according to claim 2, wherein step d) comprises sensing at least one of road markings and traffic signs.

5. The method according to claim 2, wherein step d) comprises using data of a navigation system.

6. The method according to claim 2, wherein step d) comprises counting the number of lane changes after entering the road the ego lane is positioned on.

7. The method according to claim 1, wherein step b) comprises detecting the speed of the vehicle located on the emergency lane.

8. The method according to claim 1, wherein step c1) comprises performing a lane change to a lane that is more remote to the emergency lane than the ego lane.

9. The method according to claim 1, wherein step c1) comprises performing a lateral shift within the ego lane without performing a lane change.

10. The method according to claim 1, wherein before step c) the method further comprises:
e) sensing at least a second lane being adjacent to the ego lane in an opposite direction compared to the emergency lane, and determine when a lane change to the second lane lane is critical.

11. The method according to claim 1, wherein the method further comprises:
g) changing the lateral position of the ego vehicle back to the initial lateral position after passing the vehicle located on the emergency lane.

12. The method according to claim 1, wherein the method further comprises:
h) increasing the speed of the ego vehicle after passing the vehicle on the emergency lane back to the initial speed.

13. The method according to claim 1, wherein step b) comprises detecting if the vehicle being located on the emergency lane is an emergency vehicle.

14. A driver support system for a vehicle, comprising:
at least one environmental sensor for sensing the environment of the vehicle; and
a control unit for processing the data provided by the at least one environmental sensor,
the control unit being configured for performing a method comprising:
monitoring the emergency lane,
determining when a vehicle is present on the emergency lane in front of the ego vehicle, and
c) before the ego vehicle passes the vehicle located on the emergency lane, performing at least one of:
c1) changing the lateral position of the ego vehicle to increase the lateral distance to the emergency lane, and
c2) decreasing the speed of the ego vehicle.

15. A vehicle comprising a driver support system as claimed in claim 14.
